(19) United States
(12) Patent Application Publication
(10) Pub. No.: US 2019/0194847 A1
(43) Pub. Date: Jun. 27, 2019

(54) Solution-Spun Polyamide Nanofiber Nonwovens

(71) Applicant: Ascend Performance Materials Operations LLC, Houston, TX (US)

(72) Inventors: Harrie P. Schoots, League City, TX (US); Wai-Shing Yung, Pensacola, FL (US); Scott E. Osborn, Pensacola, FL (US); Craig A. Trask, Pensacola, FL (US)

(21) Appl. No.: 16/308,251

(22) PCT Filed: Jun. 6, 2017
(86) PCT No.: PCT/US17/36062

§ 371 Date: Dec. 7, 2018

Related U.S. Application Data
(60) Provisional application No. 62/348,524, filed on Jun. 10, 2016.
(60) Provisional application No. 62/348,462, filed on Jun. 10, 2016.

(51) Int. Cl. D04H 3/16; D04H 1/4334; D04H 3/009; D04H 1/732; D04H 3/03; D04H 1/56; B01D 39/16; B01D 46/54

(52) U.S. Cl. CPC D04H 3/16; B01D 2239/1258; D04H 3/009; D04H 1/732; D04H 3/03; D04H 1/56; B01D 39/1623; B01D 46/546; D10B 2501/00; D10B 2505/04; B01D 2239/0208; B01D 2239/1233; B01D 2239/0618; B01D 2239/10; D04H 1/4334

(57) ABSTRACT

A polymer, applications thereof, and method of making a nanofiber nonwoven product is disclosed which includes: providing a spinnable polyamide polymer composition comprising a solution of a polyamide in a suitable solvent, wherein the polyamide has a Relative Viscosity of from 30-300; a basis weight greater than 1 gm/m², solution-spinning the polyamide polymer composition into a plurality of nanofibers having an average fiber diameter of less than 1 micron (1000 nanometers); and forming the nanofibers into said nonwoven product which thereby has an average nanofiber diameter of less than 1 micron (1000 nanometers). Preferably, the nonwoven product is solution-spun from a process selected from (i) centrifugal spinning using a rotating spinneret or (ii) 2-phase propellant-gas spinning including extruding the polyamide polymer composition in liquid form with pressurized gas through a fiber-forming channel. Suitable solvents include formic acid, sulfuric acid, trifluoroacetic acid, hexafluoroisopropanol (HFIP) and phenols including m-cresol.

### CLAIM FOR PRIORITY

This patent application is a national phase application of PCT/US2017/036062 having an international filing date of Jun. 06, 2017, based on U.S. Provisional Application Ser. No. 62/348,462 filed Jun. 10, 2016, entitled “Solution-Spun Polyamide Nanofiber Nonwovens ”, and U.S. Provisional Application Ser. No. 62/348,524 filed Jun. 10, 2016, entitled “Polyamide Nanofiber Nonwovens” the priorities of which are all hereby claimed and their disclosures incorporated herein by reference.

### TECHNICAL FIELD

The present invention relates to polyamide nanofiber nonwovens useful for air filtration, breathable fabrics for apparel and packaging, as well as other applications.

### BACKGROUND

Polymer membranes, including nanofiber and microfiber nonwovens are known in the art and are used for a variety of purposes, including in connection with filtration media and apparel. Known techniques for forming finely porous polymer structures include xerogel and aerogel membrane formation, electrospinning, melt-blowing, as well as centrifugal-spinning with a rotating spinneret and two-phase polymer extrusion through a thin channel using a propellant gas.

United States Patent Application Publication No. US 2014/0097558 A1, of Lustenberger, entitled “Nanofiber Filtering Material for Disposable/Reusable Respirators” relates generally to methods of manufacture of a filtration media, such as a personal protection equipment mask or respirator, which incorporates an electrospinning process to form nanofibers onto a convex mold, which may, for example, be in the shape of a human face. See, also, United States Patent Application Publication No. US 2015/0145175 A1, of Lustenberger, also entitled “Nanofiber Filtering Material for Disposable/Reusable Respirators”.

WO 2014/074818 A2, of Emergent Sensor Technologies, discloses nanofibrous meshes and xerogels used for selectively filtering target compounds or elements from a liquid. Also described are methods for forming nanofibrous meshes and xerogels, methods for treating a liquid using nanofibrous meshes and xerogels, and methods for analyzing a target compound or element using nanofibrous meshes and xerogels.

WO 2015/003170 A2, of The North Face Apparel Corp., relates to nonwoven textiles consisting of webs of superfine fibers, i.e., fibers with diameters in nanoscale or micronscale ranges, for use in articles that have, for example a predetermined degree of waterproofness with breathability, or windproofness with breathability.

WO 2015/153477 A1, also of North Face Apparel Corp., relates to a fiber construct suitable for use as a fill material for insulation or padding, comprising: a primary fiber structure comprising a predetermined length of fiber; a secondary fiber structure, the secondary fiber structure comprising a plurality of relatively short loops spaced along a length of the primary fiber. Among the techniques enumerated for forming the fiber structures include electrospinning, melt-blowing, melt-spinning and centrifugal-spinning. See page 18, lines 8-12. The products are reported to mimic goose-down, with fill power in the range of 550 to 900; page 40, lines 9-13.

U.S. Pat. No. 7008465 of Donaldson Company Inc. relates to cleanable high efficiency filter media structure and applications for use. Disclosed is a filter structure and system having a nanofiber layer comprising a polymeric material having a basis weight of about 3×10⁻⁷ to 6×10⁻⁵ gm/cm².

Despite the variety of techniques and materials proposed, conventional products have much to be desired in terms of manufacturing costs, processability and product properties.

### SUMMARY OF INVENTION

Disclosed herein is a method of making a nanofiber nonwoven product which includes:
providing a spinnable polyamide polymer composition comprising a solution of a polyamide in a suitable solvent, wherein the polyamide has a Relative Viscosity of from 30-300; solution-spinning the polyamide polymer composition into a plurality of nanofibers having an average fiber diameter of less than 1000 nanometers; and forming the nanofibers into said nonwoven product which thereby has an average nanofiber diameter of less than 1000 nanometers. Preferably, the nonwoven product is solution-spun from a process selected from (i) centrifugal spinning using a rotating spinneret or (ii) 2-phase propellant-gas spinning including extruding the polyamide polymer composition in liquid form with pressurized gas through a fiber-forming channel. Suitable solvents include formic acid, sulfuric acid, trifluoroacetic acid, hexafluoroisopropanol (HFIP) and phenols including m-cresol.

Particularly preferred polyamides include:

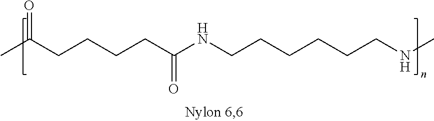

As well as copolymers, blends and alloys of Nylon 6,6 with

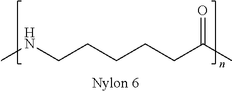

Other embodiments include nylon derivatives, copolymers, blends and alloys containing or prepared from Nylon 6,6 or Nylon 6 or copolymers with the repeat units noted above including but not limited to: N6T/66, N612, N6/66, N11, and N12, wherein “N” means Nylon. Herein, the “N” is interchangeably used with or without the numbering. Those of skill in the art will recognize the nylon meaning. Another preferred embodiment includes High Temperature Nylons as well as blends, derivatives or copolymers containing them. Furthermore, another preferred embodiment includes long chain aliphatic polyamides made with long chain diacids, as well as blends, derivatives, or copolymers containing them.

Preferred ranges for Relative Viscosities for the polyamide include: 35-300, 40-255, 35-100, 35-55, and 40-52.5. Preferred basis weights include greater than 1 gm/m².

The invention is appreciated by reference to FIGS. 1A, 1B, 2A, 2B which show nanofiber nonwovens of the invention. FIG. 1A shows the nanofiber nonwoven of Examples 3 and 4 at low magnification, while FIG. 1B shows the same product at higher magnification. The product of FIGS. 1A, 1B were made with a nylon polyamide having a Relative Viscosity of 51 and has an average nanofiber diameter of 288 nanometers. FIGS. 2A and 2B are similar photomicrographs of the products of Examples 1 and 2 made with material having a Relative Viscosity of 42 and has an average fiber diameter of 302 nanometers.

The products exhibit surprising filtration efficiency. Despite the relatively dense macrostructure, the Air Permeability Values of the products are especially surprising in that the products remain permeable to air. The products of the invention are thus uniquely suited for application in filtration, apparel and packaging, as hereinafter described in more detail where these properties play an important role.

### BRIEF DESCRIPTION OF DRAWINGS

The invention is described in detail below with reference to the drawings wherein like numerals designate similar parts and wherein:

FIG. 1A is a photomicrograph of a nanofiber nonwoven product made with Nylon 6,6 of a Relative Viscosity of 51 at a magnification of 570×;

FIG. 1B is a photomicrograph of the product of FIG. 1A at a magnification of 20,500×;

FIG. 2A is a photomicrograph of a nanofiber nonwoven product made with Nylon 6,6 of a Relative Viscosity of 42 at a magnification of 560×;

FIG. 2B is a photomicrograph of the product of FIG. 2A at a magnification of 22,000×;

FIG. 3 is a schematic perspective view of a centrifugal-spinning apparatus and fiber distribution system;

FIG. 4 is a schematic diagram of portions of the apparatus of FIG. 3;

FIG. 5 is a schematic diagram of a 2-phase propellant-gas spinning system useful in connection with the present invention;

FIG. 6 details Example 1 results, in particular, FIG. 6A is a plot of fiber diameter versus count; FIG. 6B is a histogram showing filtration efficiency; FIG. 6C is a histogram showing pressure drop seen with filtration efficiency testing; and FIG. 6D is a plot of Air permeability;

FIG. 7 details Example 2 results, in particular, FIG. 7A is a plot of fiber diameter versus count; FIG. 7B is a histogram showing filtration efficiency; FIG. 7C is a histogram showing pressure drop seen with filtration efficiency testing; and FIG. 7D is a plot of Air permeability;

FIG. 8 details Example 3 results, in particular, FIG. 8A is a plot of fiber diameter versus count; FIG. 8B is a histogram showing filtration efficiency; FIG. 8C is a histogram showing pressure drop seen with filtration efficiency testing; and FIG. 8D is a plot of Air permeability; and

FIG. 9 details Example 4 results, in particular, FIG. 9A is a plot of fiber diameter versus count; FIG. 9B is a histogram showing filtration efficiency; FIG. 9C is a histogram showing pressure drop seen with filtration efficiency testing; and FIG. 9D is a plot of Air permeability.

### DETAILED DESCRIPTION

The invention is described in detail below in connection with the Figures for purposes of illustration, only. The invention is defined in the appended claims. Terminology used herein is given its ordinary meaning consistent with the definitions set forth below; GSM refers to basis weight in grams per square meter, RV refers to Relative Viscosity and so forth.

Percents, parts per million (ppm) and the like refer to weight percent or parts by weight based on the weight of the composition unless otherwise indicated.

Typical definitions and test methods are further recited in US 2015/0107457, and US 2015/0111019. The term “nanofiber nonwoven product” for example, refers to a web of a multitude of essentially randomly oriented fibers where no overall repeating structure can be discerned by the naked eye in the arrangement of fibers. The fibers can be bonded to each other, or can be unbounded and entangled to impart strength and integrity to the web. The fibers can be staple fibers or continuous fibers, and can comprise a single material or a multitude of materials, either as a combination of different fibers or as a combination of similar fibers each comprising of different materials. The nanofiber nonwoven product is constructed predominantly of nanofibers. “Predominantly” means that greater than 50% of the fibers in the web are nanofibers, The term “nanofiber” refers to fibers having a number average diameter less than 1000 nm. In the case of non-round cross-sectional nanofibers, the term “diameter” as used herein refers to the greatest cross-sectional dimension,

Basis Weight may be determined by ASTM D-3776 and reported in g/m².

“Consisting essentially of” and like terminology refers to the recited components and excludes other ingredients which would substantially change the basic and novel characteristics of the composition or article. Unless otherwise indicated or readily apparent, a composition or article consists essentially of the recited or listed components when the composition or article includes 90% or more by weight of the recited or listed components. That is, the terminology excludes more than 10% unrecited components.

To the extent not indicated otherwise, test methods for determining average fiber diameters, and, filtration efficiency are as indicated in Hassan et al., J Membrane Sci., 427, 336-344, 2013, unless otherwise specified.

Air permeability is measured using an Air Permeability Tester, available from Precision Instrument Company, Hagerstown, Md. Air permeability is defined as the flow rate of air at 23±1° C. through a sheet of material under a specified pressure head. It is usually expressed as cubic feet per minute per square foot at 0.50 in. (12.7 mm) water pressure, in cm³ per second per square cm or in units of elapsed time for a given volume per unit area of sheet. The instrument referred to above is capable of measuring permeability from 0 to approximately 5000 cubic feet per minute per square foot of test area. For purposes of comparing permeability, it is convenient to express Air Permeability values normalized to 5 GSM basis weight. This is done by measuring Air Permeability Value and basis weight of a sample (@ 0.5″ H₂O typically), then multiplying the actual Air Permeability Value by the ratio of actual basis weight in GSM to 5. For example, if a sample of 15 GSM basis weight has a Value of 10 CFM/ft², its Normalized 5 GSM Air Permeability Value is 30 CFM/ft².

As used herein, polyamide composition and like terminology refers to compositions containing polyamides including copolymers, polymer blends, alloys and derivatives. A suitable alloy may include for example, 20% Nylon 6, 60% Nylon 6,6 and 20% by weight of a polyester. In cases where alloys are used, it may be necessary to use a carefully selected solvent or blend of solvents to optimize results. In cases where the polyamide composition consists essentially of polyamides, preferred solvents include a solvent selected from: formic acid, sulfuric acid, trifluoroacetic acid, hexafluoroisopropanol (HFIP) and phenols including m-cresol.

Exemplary polyamides and polyamide compositions are described in Kirk-Othmer, Encyclopedia of Chemical Technology, Vol. 18, pp. 328-371 (Wiley 1982), the disclosure of which is incorporated by reference.

Briefly, polyamides are products that contain recurring amide groups as integral parts of the main polymer chains. Linear polyamides are of particular interest and may be formed from condensation of bifunctional monomers as is well known in the art. Polyamides are frequently referred to as nylons. Although they generally are considered as condensation polymers, polyamides also are formed by addition polymerization. This method of preparation is especially important for some polymers in which the monomers are cyclic lactams (i.e. Nylon 6). Particular polymers and copolymers and their preparation are seen in the following patents: U.S. Pat. No. 4,760,129, entitled “Process for Preparing Highly Viscous Polyhexamethyleneadipamide”, to Haering et al.; U.S. Pat. No. 5,504,185, entitled “Process for Production of Polyam ides, Polyamides Produced by Said Process and Polyamide Film or Sheet”, to Toki et al.; U.S. Pat. No. 5,543,495, entitled “Process for Increasing the Molecular Weight of Polyamides and Other Condensation Polymers”, to Anolick et al.; U.S. Pat. No. 5,698,658, entitled “Linear Very High Molecular Weight Polyamides and Process for Producing Them”, to Dujari et al.; U.S. Pat. No. 6,011,134, entitled “Method for Manufacturing Poly(Hexamethylene Adipamide) from Monomethyladipate and Hexamethylenediamine”, to Marks et al.; U.S. Pat. No. 6,136,947, entitled “Process and Device for the Standardized Continuous Production of Polyamides”, to Wiltzer et al.; U.S. Pat. No. 6,169,162, entitled “Continuous Polyamidation Process”, to Bush et al.; “Polyamide Chain Extension Process and Related Polyamide Product”, to Zahr, U.S. Pat. No. 7,138,482, entitled “Production Method of Polyamide”, to Tanaka et al.; U.S. Pat. No. 7,381,788, entitled “Method for Continuous Production of Polyamide”, to Tsujii et al.; and U.S. Pat. No. 8,759,475, entitled “Continuous Production of Polyamides”, to Thierry et al.

A class of polyamides particularly preferred for some applications includes High Temperature Nylons (HTN's) as are described in Glasscock et al., High Performance Polyam ides Fulfill Demanding Requirements for Automotive Thermal Management Components, (Dupont), http://www2.dupont.com/Automotive/en_US/assets/down loads/knowledge20center/HTN-whitepaper-R8.pdf available online Jun. 10, 2016. Such polymers typically include one or more of the structures seen in the following and shown as representative:

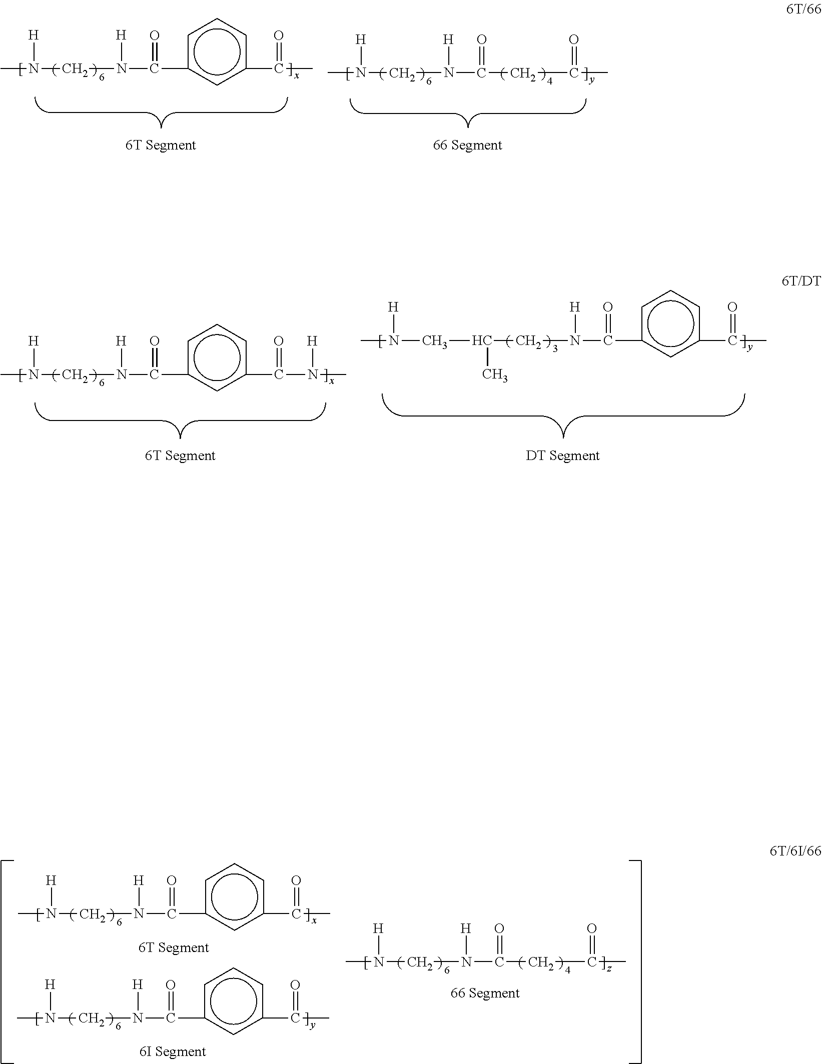

Relative viscosity (RV) of polyamides refers to the ratio of solution or solvent viscosities measured in a capillary viscometer at 25° C. (ASTM D 789). For present purposes the solvent is formic acid containing 10% by weight water and 90% by weight formic acid. The solution is 8.4% by weight polymer dissolved in the solvent.

The relative viscosity, (ηᵣ), is the ratio of the absolute viscosity of the polymer solution to that of the formic acid:

ηᵣ=(ηₚ/η_{f})=(fᵣ×dₚ×fₚ)η_{f}
where: dₚ=density of formic acid-polymer solution at 25° C.,
tₚ=average efflux time for formic acid-polymer solution, s
η_{f}=absolute viscosity of formic acid, kPa×s(E+6cP)
fᵣ=viscometer tube factor, mm²/s (cSt)/s=ηᵣ/t₃

A typical calculation for a 50 RV specimen is as follows:

ηᵣ=(fᵣ×dₚ×tₚ)/η_{f}
Where
fᵣ=viscometer tube factor, typically 0.485675 cSt/s
dₚ=density of the polymer-formic solution, typically 1.1900 g/ml
tₚ=average efflux time for polymer-formic solution, typically 135.00 s
η_{f}=absolute viscosity of formic acid, typically 1.56 cP giving an RV of
ηᵣ=(0.485675 cSt/s×1.1900 g/ml×135.00 s)/1.56 cP=50.0

The term t₃ is the efflux time of the S-3 calibration oil used in the determination of the absolute viscosity of the formic acid as required in ASTM D789.

Centrifugal-spinning refers to a process for making polymer fibers by spinning through a rotating spinneret as is noted in WO 2015/153477 (North Face Apparel Corp). Centrifugal-spinning is one preferred method of making the inventive nanofiber nonwovens of the invention.

A centrifugal-spinning system typically includes a spinneret that is coupled to a source of fluid or flowable material that is formable into a fiber. The source of material may be from a supply source, such as a reservoir or hopper for continuously feeding the spinneret. The spinneret could itself include a reservoir or hopper of material that is rotated with the spinneret if so desired. The flowable material could be molten material or a solution of material. The spinneret is mechanically coupled to a motor that rotates the spinneret in a circular motion. In most cases, the rotating element is rotated within a range of about 500 to about 100,000 RPM. More typically, the rotation during which material is ejected is at least 5,000 RPM when making nanofibers.

During rotation, a selected material, for example, a polymer melt or polymer solution, is ejected as a stream of material from one or more outlet ports on the spinneret into the surrounding atmosphere. The outward radial centrifugal force stretches the polymer stream as it is projected away from the outlet port, and the stream travels in a curled trajectory due to rotation-dependent inertia. Stretching of the extruded polymer stream is believed to be important in reducing stream diameter over the distance from the nozzle to a collector as well as providing tortuosity to the products. The ejected material is solidifies into a superfine fiber by the time it reaches a collector. The collecting surface could be static or movable, for example, the fiber may be directed onto a continuous belt if so desired.

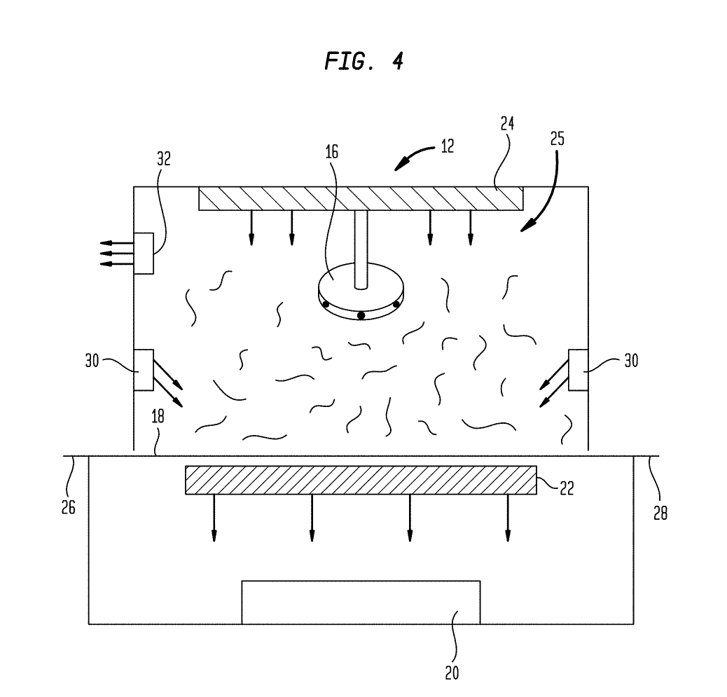

One preferred system is depicted schematically in FIGS. 35 and 36 appearing in U.S. Pat. No. 8,777,599 to Peno et al. As is seen therein, and described briefly in connection with the attached FIGS. 3 and 4 of the present invention.

A top driven fiber producing system is particularly useful for depositing fibers onto a substrate. A configuration for depositing fibers onto a substrate is shown in FIG. 3. Substrate deposition system 10 includes a deposition system 12 and a substrate transfer system 14. Deposition system 12 includes a fiber producing system 16. The deposition system produces and directs fibers produced by a fiber producing device toward a substrate 18 disposed below the fiber producing device during use. Substrate transfer system moves a continuous sheet of substrate material through the deposition system.

Deposition system 12 includes a top mounted fiber producing device including a rotating spinneret indicated at 16. During use, fibers produced by fiber producing device 16 are deposited onto substrate 18.

A schematic diagram of deposition system 12 is depicted in FIG. 4. The fiber deposition system may include one or more of: a vacuum system 20, an electrostatic plate 22, and a gas flow system 24. A vacuum system produces a region of reduced pressure under substrate 18 such that fibers produced by fiber producing device 16 are drawn toward the substrate due to the reduced pressure. Alternatively, one or more fans may be positioned under the substrate to create an air flow through the substrate. Gas flow system 24 produces a gas flow 25 that directs fibers formed by the fiber producing device toward the substrate. The gas flow system may be a pressurized air source or one or more fans that produce a flow of air (or other gas). The combination of vacuum and air flow systems are used to produce a “balanced air flow” from the top of the deposition chamber through the substrate to the exhaust system by using forced air (fans, pressurized air) and exhaust air (fans, to create an outward flow) and balancing and directing the airflow to produce a fiber deposition field down to the substrate. Deposition system 12 includes substrate inlet 26 and substrate outlet 28.

Electrostatic plate 22 is also positioned below substrate 18. The electrostatic plate is a plate capable of being charged to a predetermined polarity. Typically, fibers produced by the fiber producing device have a net charge. The net charge of the fibers may be positive or negative, depending on the type of material used. To improve deposition of charged fibers, an electrostatic plate may be disposed below substrate 18 and be charged to an opposite polarity as the produced fibers. In this manner, the fibers are attracted to the electrostatic plate due to the electrostatic attraction between the opposite charges. The fibers become embedded in the substrate as the fibers move toward the electrostatic plate.

A pressurized gas producing and distribution system may be used to control the flow of fibers toward a substrate disposed below the fiber producing device. During use fibers produced by the fiber producing device are dispersed within the deposition system. Since the fibers are composed primarily of microfibers and/or nanofibers, the fibers tend to disperse within the deposition system. The use of a pressurized gas producing and distribution system may help guide the fibers toward the substrate. The pressurized gas producing and distribution system includes downward gas flow device 24 and a lateral gas flow device 30. Downward gas flow device 24 is positioned above or even with the fiber producing device to facilitate even fiber movement toward the substrate. One or more lateral gas flow devices 30 are oriented perpendicular to or below the fiber producing device. If desired, lateral gas flow devices 30 have an outlet width equal to the substrate width to facilitate even fiber deposition onto substrate. The angle of the outlet of one or more lateral gas flow devices 30 may be varied to allow better control of the fiber deposition onto the substrate. Each lateral gas flow devices 30 may be independently operated.

During use of the deposition system, fiber producing device 16 may produce various gasses due to evaporation of solvents (during solution spinning) and material gasification (during melt spinning). Such gasses, if accumulated in the deposition system may begin to effect the quality of the fiber produced. Optionally, the deposition system includes an outlet fan 32 to remove gasses produced during fiber production from the deposition system.

Substrate transfer system 14 is capable of moving a continuous sheet of substrate material through the deposition system. Substrate transfer system 14 may include a substrate reel 34 and a take up reel system 36. During use, a roll of substrate material is placed on substrate reel 34 and threaded through deposition system 12 to the substrate take up reel system 36. During use, substrate take up reel system 36 rotates, pulling substrate through deposition system at a predetermined rate. In this manner, a continuous roll of a substrate material may be pulled through the fiber deposition system and the basis weight of a nanofiber nonwoven deposited on the substrate controlled by controlling the speed of the collecting substrate.

Further discussion and illustration of centrifugal-spinning processes are seen in U.S. Pat. No. 8,658,067 to Peno et al., entitled “Apparatuses and Methods for the Deposition of Microfibers and nanofibers on a Substrate”, as well as: WO 2012/109251, and equivalent systems seen in U.S. Pat. No. 8,747,723 to Marshall et al., entitled “Solution Spun Fiber Process’ and U.S. Pat. No. 8,277,711 to Huang et al., entitled “Production of Nanofibers by Melt Spinning”.

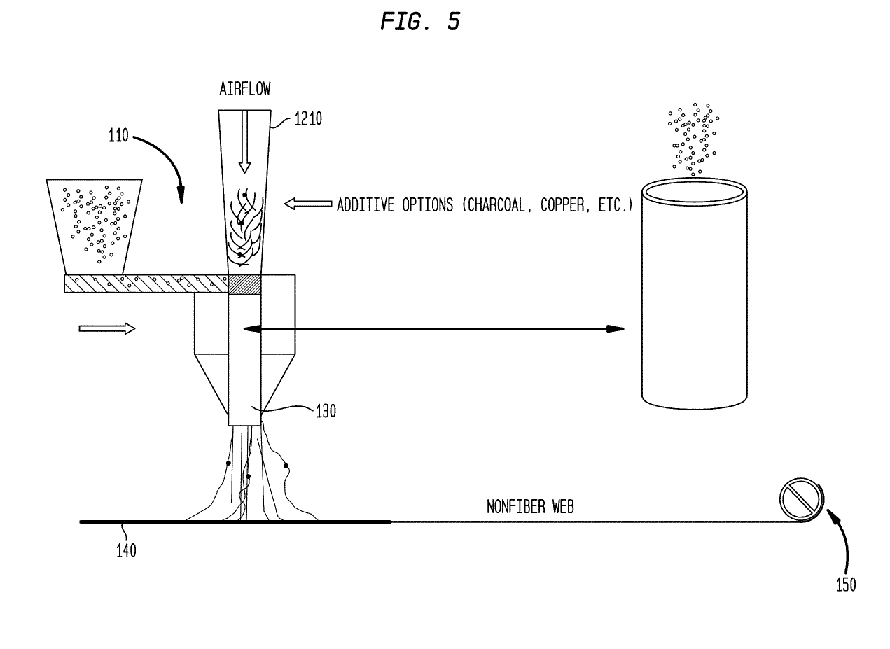

Another method of making the inventive nanofiber nonwovens is by way of 2-phase spinning with propellant gas through a spinning channel as is described generally in U.S. Pat. No. 8,668,854 to Marshall et al. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into fibers by the propellant gas flow. Here again, a moving collector belt may be used and the basis weight of the nanofiber nonwoven controlled by regulating the speed of the belt. The distance of the collector may also be used to control fineness of the nanofiber nonwoven. The process is better understood with reference to FIG. 5.

FIG. 5 illustrates schematically operation of a system for spinning a nanofiber nonwoven including a polymer feed assembly 110, an air feed 120, a spinning cylinder 130, a collector belt 140 and a take up reel 150. During operation, polymer melt or solution is fed to spinning cylinder 130 where it flows through a thin channel in the cylinder with high pressure air, shearing the polymer into nanofibers. Details are provided in the aforementioned U.S. Pat. No. 8,668,854. The throughput rate and basis weight is controlled by the speed of the belt. Optionally, functional additives such as charcoals, copper or the like can be added with the air feed, if so desired.

In an alternate construction of the spinneret used in the system of FIG. 5, particulate material may be added with a separate inlet as is seen in U.S. Pat. No. 8,808,594 to Marshall et al., entitled “Coform Fibrous Materials and Method for Making Same”.

Polyamide resins of the present invention have an RV of from 30-300 with preferred ranges disclosed above. Preferred basis weight is greater than 1 gm/m².

### MATERIALS, SPINNING AND NONWOVEN FORMATION EXAMPLES

Utilizing the procedures and apparatus of the class discussed above in connection with FIGS. 3 and 4, two different grades of Nylon 6,6 were spun into a nonwoven by centrifugal-spinning onto a moving collector belt. One resin had a Relative Viscosity of 42 and included a copper halide additive present in 60 ppm. A second resin had a Relative Viscosity of 51. The finished nonwovens were disposed on a 1.5 ounce per square yard (OSY) nonwoven polypropylene substrate and analyzed for: basis weight (ASTM D-3776); average fiber diameter by SEM; filtration efficiency and pressure drop using a TSI-8130 and a polyalphaolefin nanoparticle composition @ 300 nm and a test flow rate of 32 l/m in; and Air Permeability at 0.5″ H₂0 pressure drop. These latter tests were also performed on the polypropylene substrate. Results are discussed further in the following Examples.

### Examples 1-4

In Examples 1-4, polymer solutions of 24 wt % of Nylon 6,6 in formic acid were centrifugally-spun into nanofiber nonwovens using a spinneret rotational speed of 7500 rpm, a feed rate of 12 ml/min and a head of 6.5 cm. The nonwovens were characterized for average fiber diameter, basis weight, air permeability, filtration efficiency, and pressure drop in accordance with the Hassan et al. article noted above, J Membrane Sci., 427, 336-344, 2013.

For purposes of measuring filtration efficiency, a TSI filter tester was used with a standard 3.5 micron particle size.

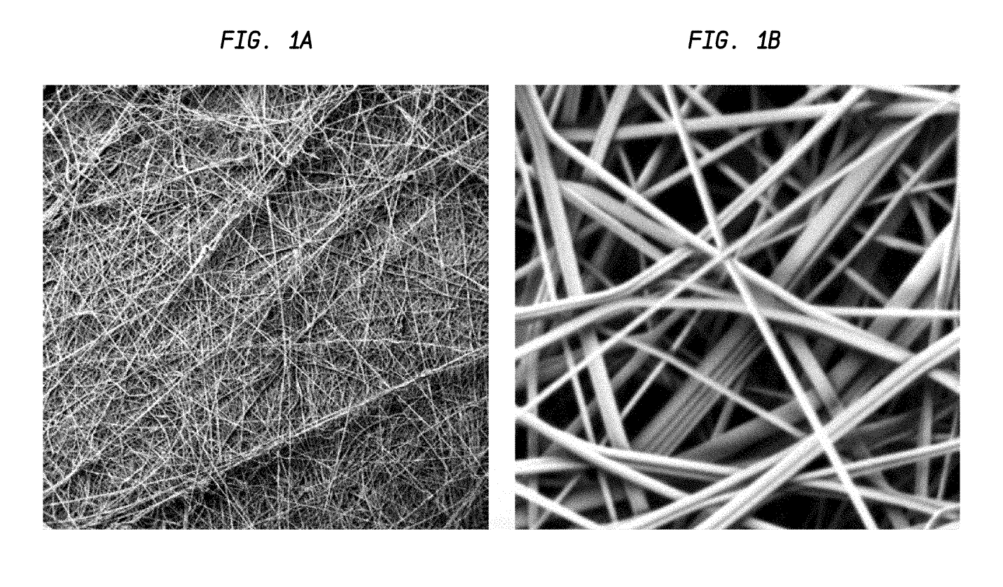

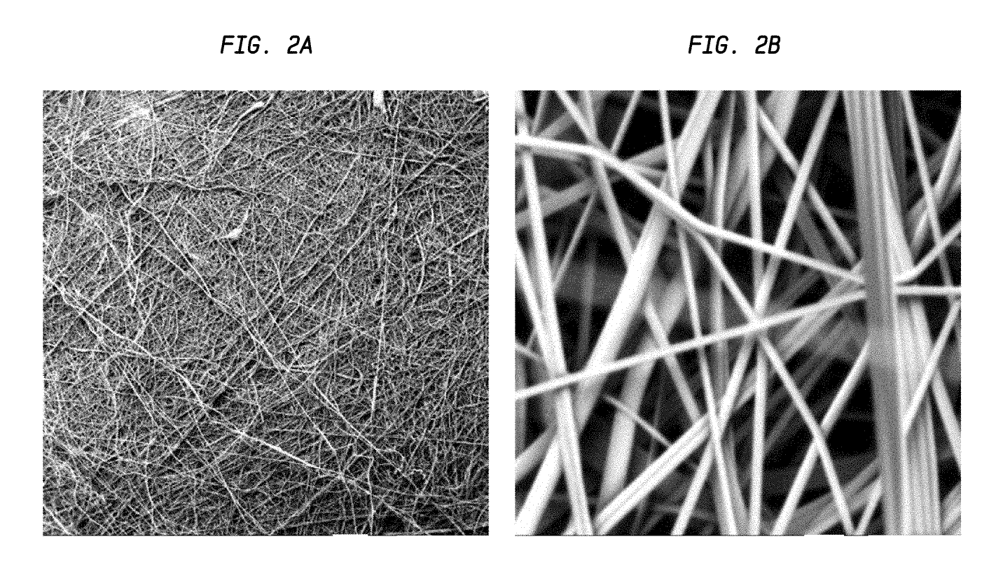

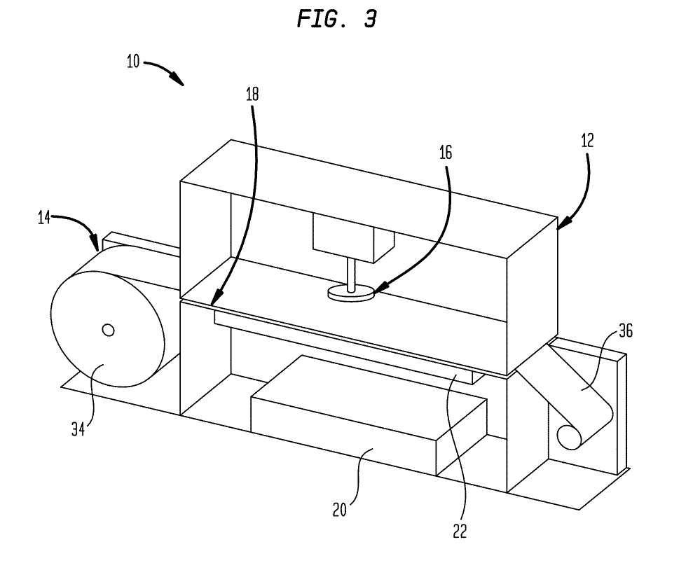

Results and details appear in Table 1 and the nonwovens produced are shown in the photomicrographs of FIGS. 1 and 2. The nonwovens had an average fiber diameter in the range of 300 nanometers.

TABLE 1
Polyamide Nanofiber Nonwoven Product Properties

| | | | | Air | | |
|---|---|---|---|---|---|---|
| | Fiber | | Basis | perme- | Filtration | Pressure |
| Resin | diameter, | Ex- | weight, | ability, | efficiency, | drop, mm |
| RV | nm | ample | GSM | CFM/ft² | % | H2O |
| 42 | 302 | 1 | 6.12 | 9.73 | 99.833 | 18.2 |
| | | 2 | 7.32 | 7.52 | 99.968 | 21.1 |
| 51 | 288 | 3 | 5.82 | 8.71 | 99.957 | 20.1 |
| | | 4 | 7.68 | 6.21 | 99.996 | 28.5 |

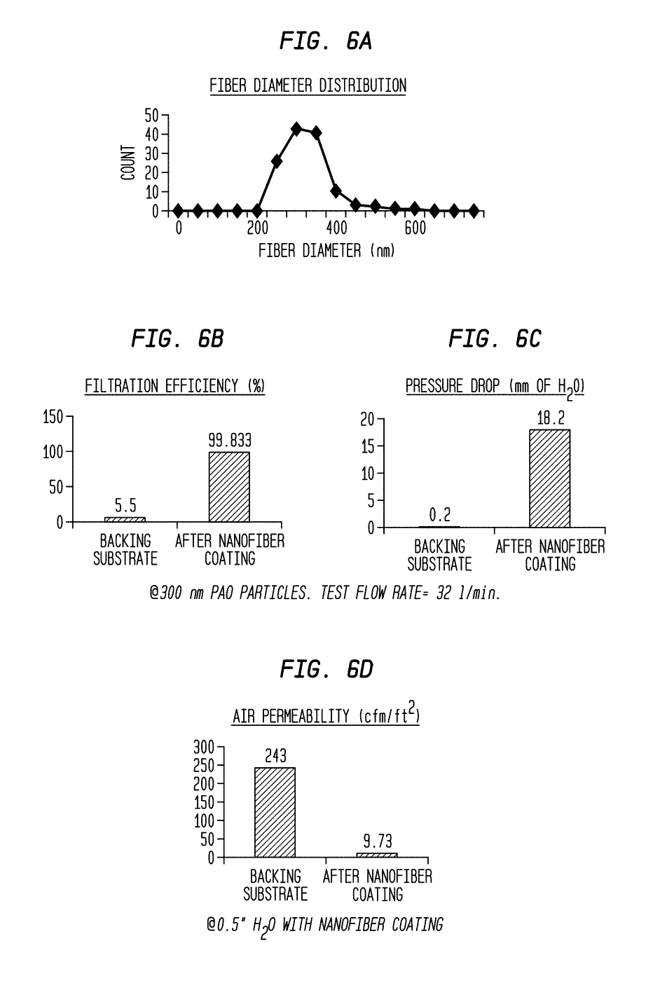

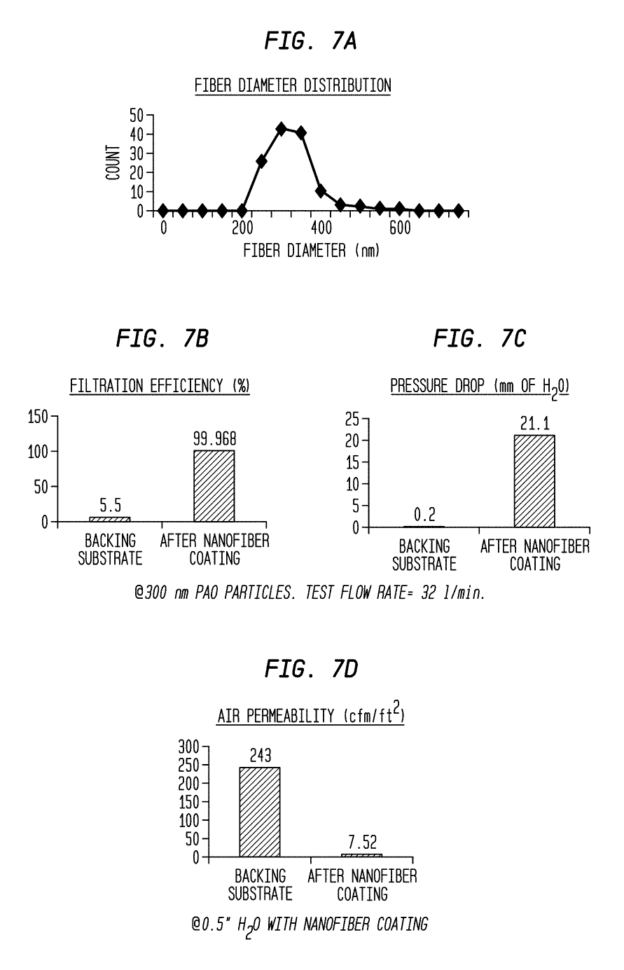

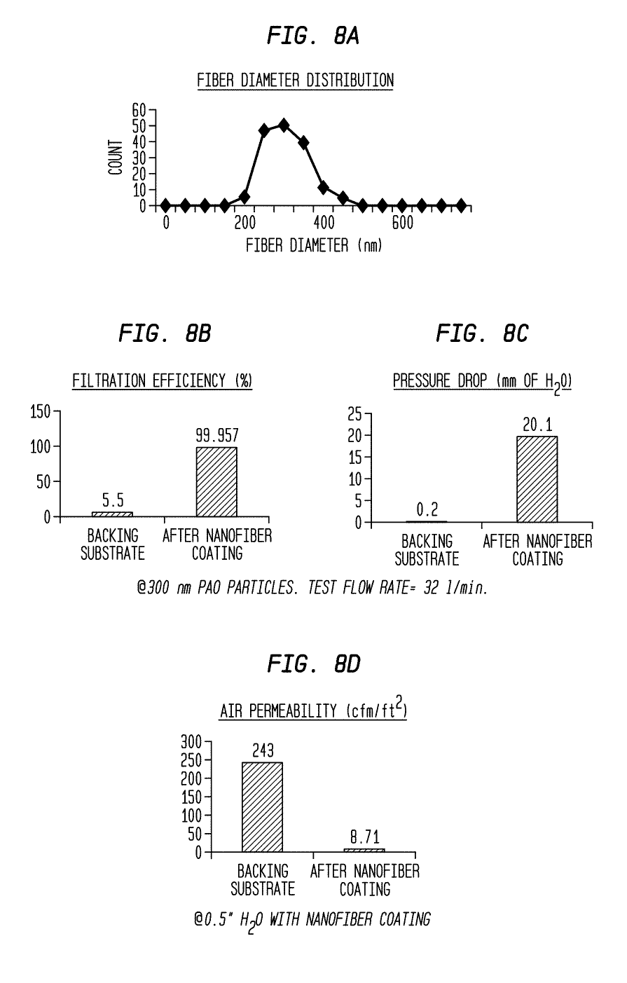

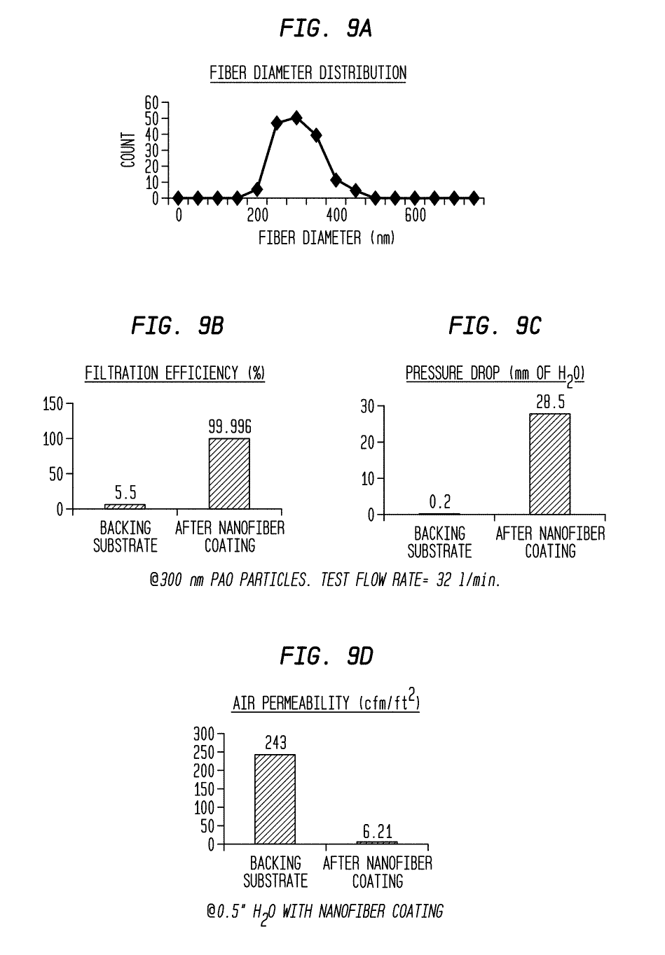

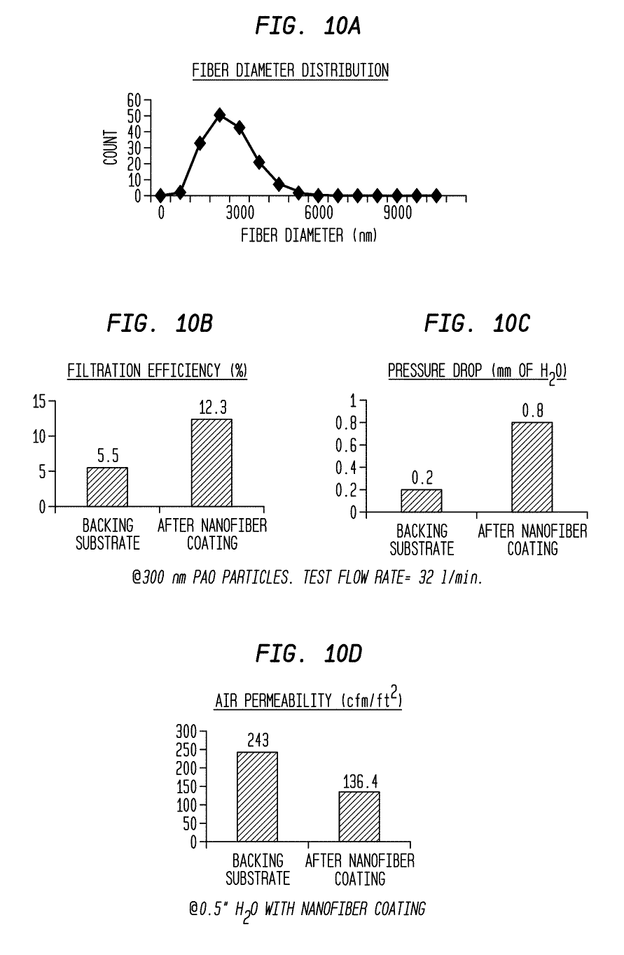

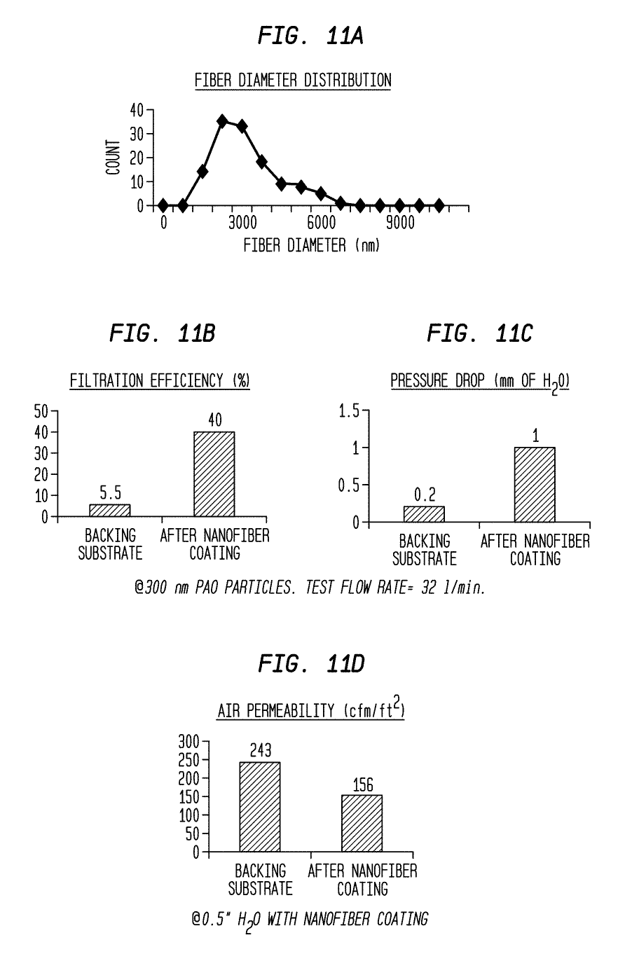

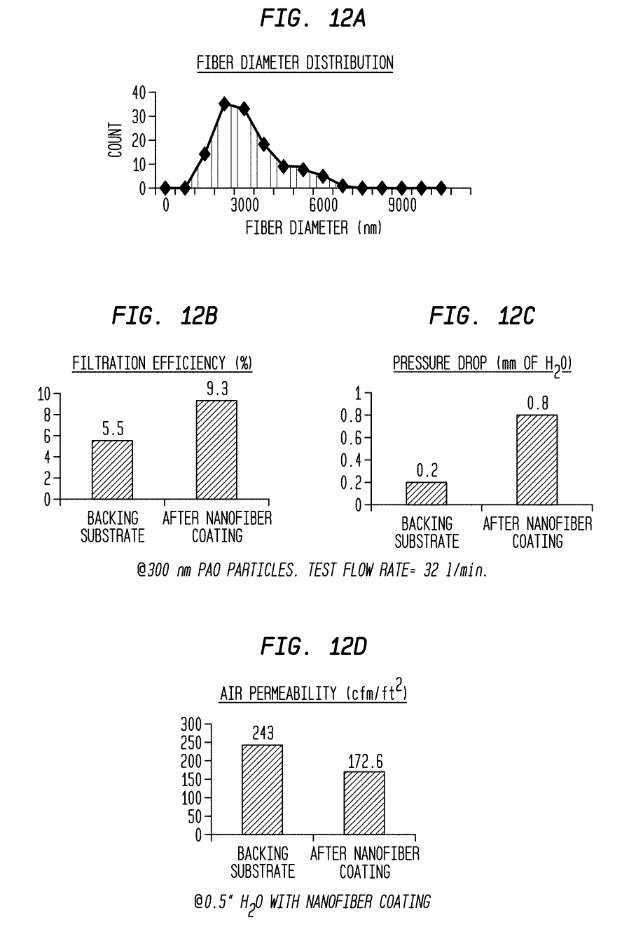

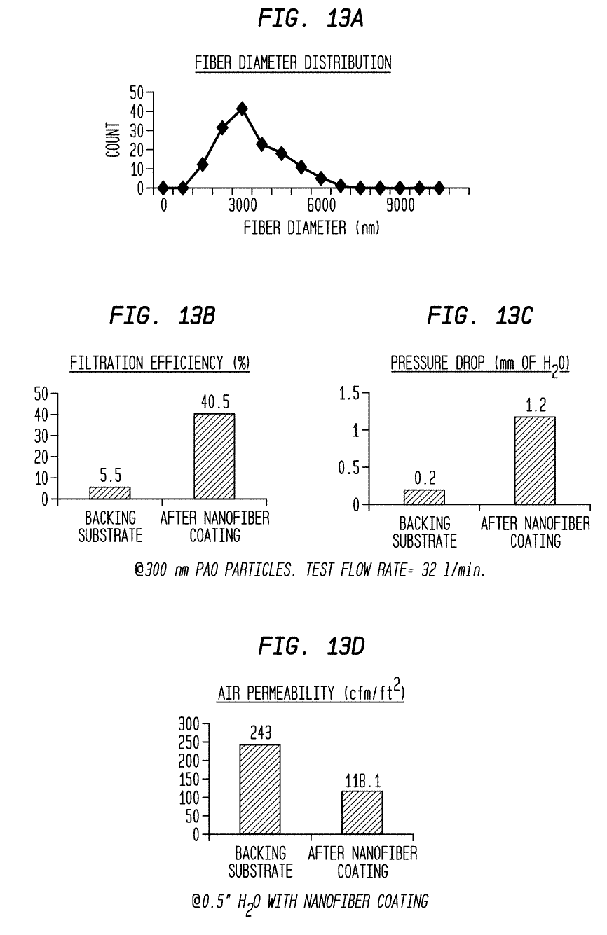

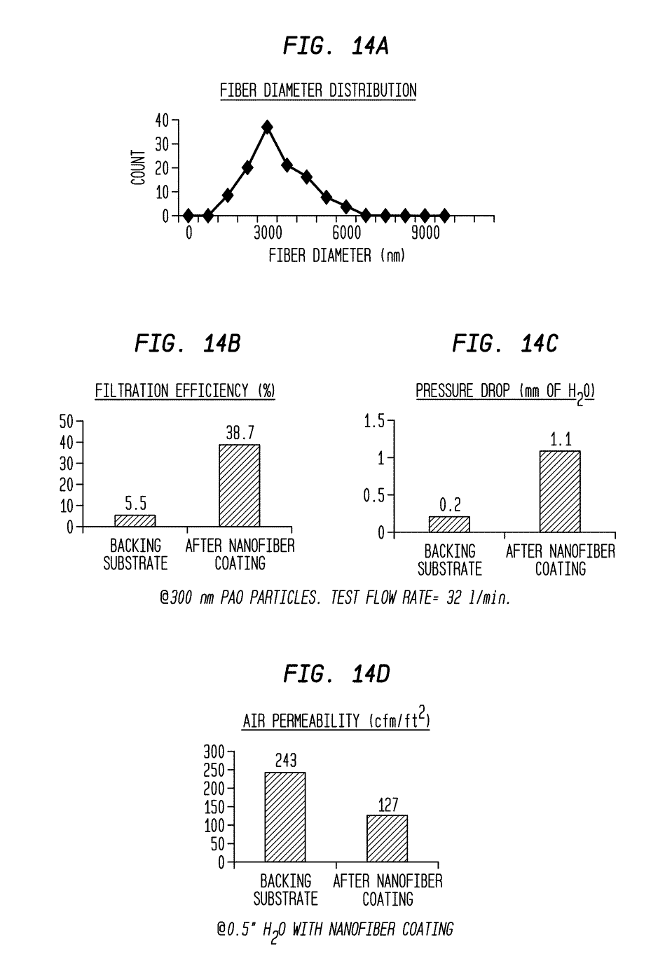

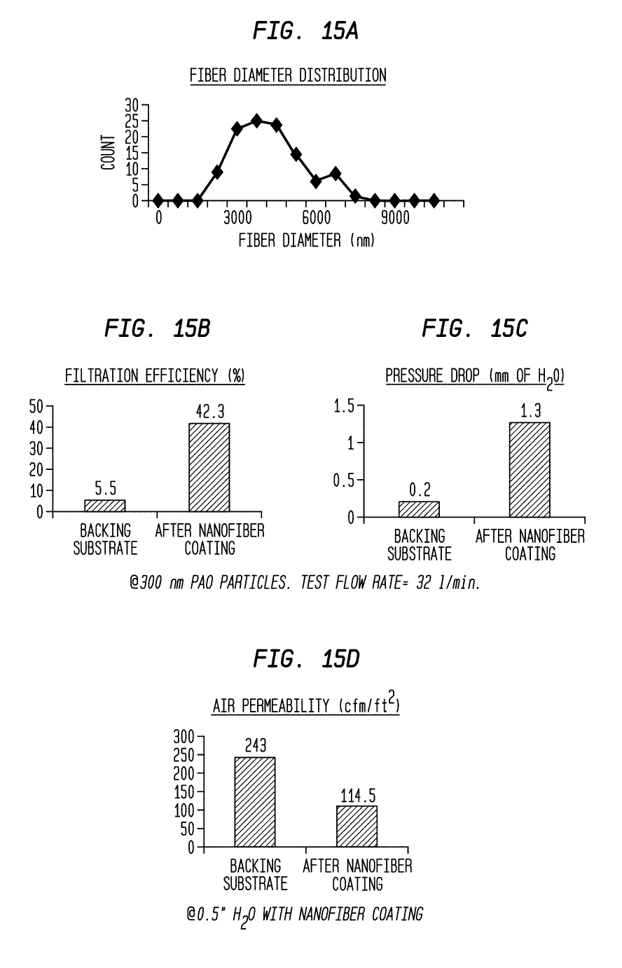

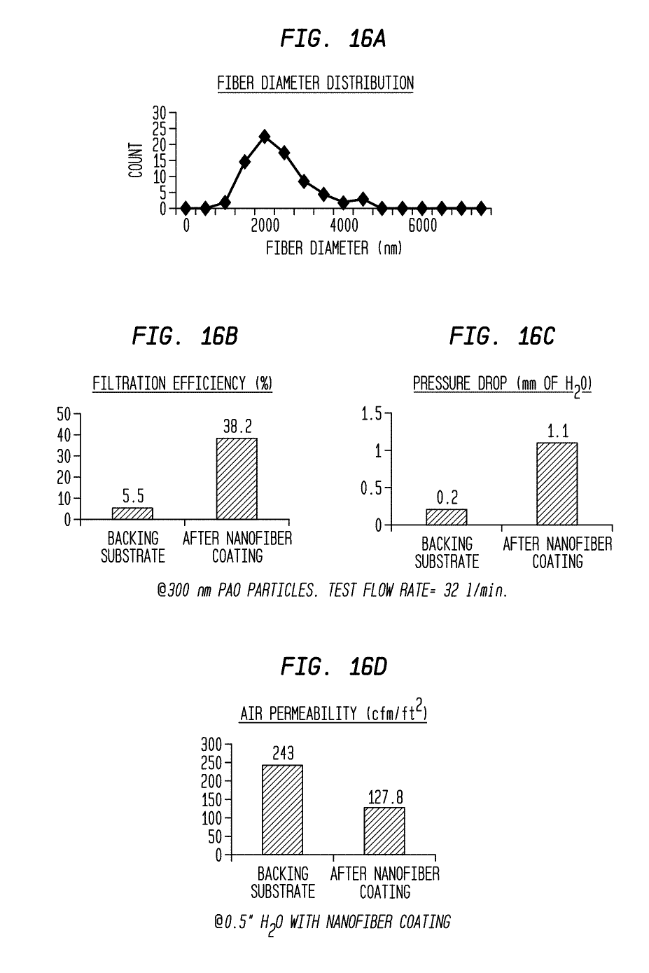

Results are further detailed in FIGS. 6 through 9.

It is appreciated from Table 1 that the nanofiber nonwovens of the invention had a remarkable filtration efficiency, more than 99.95% which is surprising, especially in view of the relatively open structure seen in FIGS. 1 and 2. Without intending to be bound by any theory, it is believed the very fine, relatively uniform morphology of the products provides a tortuous barrier on a nanoscale that resists penetration and provides permeation barrier even at relatively high void volume in the nonwoven.

The Normalized 5 GSM Air Permeability Values for Examples 1-4 are listed in Table 1A.

TABLE 1A
Normalized 5 GSM Air Permeability Values

| Example | CFM/ft² |
|---|---|
| 1 | 11.9 |
| 2 | 11.0 |
| 3 | 10.1 |
| 4 | 9.5 |

### Comparative Examples A-G

Utilizing the procedures and apparatus of the class discussed in connection with FIGS. 3 and 4 and the characterization procedures described above, the two different grades of Nylon 6,6 used in Examples 1-4 were centrifugally-spun from a polymer melt into microfiber nonwovens using a spinneret rotational speed of 4,000 rpm. The microfiber nonwovens were characterized for average fiber diameter, basis weight, air filtration efficiency and pressure drop.

TABLE 2
Polyamide Microfiber Nonwoven Product Properties

| | | | | | | Air |
|---|---|---|---|---|---|---|
| | | Fiber | Basis | Filtration | Pressure | perme- |
| Resin | Ex- | diameter, | weight, | efficiency, | drop, mm | ability, |
| RV | amples | micron | GSM | % | H2O | CFM/ft² |
| 51 | A | 2.24 | 17.56 | 12.3 | 0.8 | 136.4 |
| | B | 2.67 | 13.6 | 40 | | 156 |
| 42 | C | 2.76 | 17.38 | 9.3 | 0.8 | 172.6 |
| | D | 2.95 | 24.53 | 40.5 | 1.2 | 118.1 |
| | E | 2.98 | 38.21 | 38.7 | 1.1 | 127 |
| | F | 4.4 | 41 | 42.3 | 1.3 | 114.5 |
| | G | 2.08 | 24.5 | 38.2 | 1.1 | 127.8 |

Results are further detailed in FIGS. 10 through 16.

It is appreciated from Table 2 that the microfiber nonwoven produced had filtration efficiencies, permeability, and pressure drops vastly inferior to the nanofiber nonwovens of the invention, despite having significantly higher basis weights.

The Normalized 5 GSM Air Permeability Values for Examples A-G are listed in Table 2B.

TABLE 2B
Normalized 5 GSM Air Permeability Values

| | Normalized 5 GSM Air Permeability |
|---|---|
| Example | Value CFM/ft² |
| A | 479 |
| B | 424 |
| C | 599 |
| D | 579 |
| E | 970 |
| F | 939 |
| G | 626 |

### Comparative Examples H-J

Utilizing the procedures and apparatus of the class discussed in connection with FIGS. 3 and 4 and the characterization procedures described above, different grades of Nylon 6,6 were centrifugally-spun from a polymer solution into nanofiber nonwovens using a spinneret rotational speed of 4,000 rpm. The nanofiber nonwovens were characterized for average fiber diameter, basis weight, air filtration efficiency and pressure drop.

TABLE 3
Polyamide Microfiber Nonwoven Product Properties

| | Fiber | | Basis | Air | Filtration | Pressure | concentration |
|---|---|---|---|---|---|---|---|
| Resin | diameter, | | weight, | permeability, | efficiency, | drop mm | in formic acid |
| RV | nm | Example | GSM | CFM/ft2 | % | H2O | wt % |
| 51 | 257 | H | 4.60 | 6.78 | 99.951 | 24.7 | 22 |
| 40.5 | 233 | I | 4.86 | 6.22 | 99.988 | 31.3 | 22 |
| 255 | 253 | J | 3.49 | 7.1 | 99.833 | 24.0 | 12 |

It can be appreciated from Table 3 that, even with higher polymer relative viscosity, fibers and nonwovens with similar properties can be made.

### APPLICATIONS

The inventive nanofiber nonwovens are useful in a variety of applications due to their high temperature resistance, barrier and permeability properties, processability and surprising filtration efficiencies. The products may be used in multilayer structures including laminates in many cases.

Thus, the products are used in air filtration in the following sectors: transportation; industrial; commercial and residential.

The products are likewise suitable for barrier applications in breathable fabrics, surgical nonwovens, baby care, adult care, apparel, construction and acoustics. The compositions are useful for sound dampening in automotive, electronic and aircraft applications which may require composites of different fiber sizes for best performance. At higher basis weights, the products are used in connection with beverages, food packaging, transportation, chemical processing and medical applications such as wound dressings or medical implants.

The unique characteristics of the nonwovens of the invention provide functionality and benefits not seen in conventional products, for example, the nonwovens of the invention can be used as packaging for smoked meats. The filtration efficiency filters out unwanted particles and keeps carcinogens away from the meat during the smoking process to provide a healthier consumable end-product.

While the invention has been described in detail, modifications within the spirit and scope of the invention will be readily apparent to those of skill in the art. Such modifications are also to be considered as part of the present invention. In view of the foregoing discussion, relevant knowledge in the art and references discussed above in connection with the Background of the Invention, the disclosures of which are all incorporated herein by reference, further description is deemed unnecessary. In addition, it should be understood from the foregoing discussion that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A nanofiber nonwoven product comprising a polyamide with a Relative Viscosity of from 30-300 spun into nanofibers with an average diameter of less than 1000 nanometers, a basis weight greater than 1 gm/m², and formed into said nonwoven product.

2. The nanofiber nonwoven product according to claim 1, wherein said polyamide is Nylon 6,6.

3. The nanofiber nonwoven product according to claim 1, wherein said polyamide is a copolymer, blend or alloy of Nylon 6,6 and Nylon 6.

4. (canceled)

5. (canceled)

6. The nanofiber nonwoven product according to claim 1, wherein the nanofiber nonwoven product has a 5 GSM Normalized Air Permeability Value of less than 10 CFM/ft².

7. (canceled)

8. (canceled)

9. (canceled)

10. (canceled)

11. (canceled)

12. (canceled)

13. The nanofiber nonwoven product of claim 1, wherein the polyamide has a Relative Viscosity of from 40-52.5.

14. (canceled)

15. (canceled)

16. The nanofiber nonwoven product of claim 1, wherein the nanofibers have an average diameter of from 250-325 nanometers.

17. The nanofiber nonwoven product of claim 1, wherein the nonwoven product has a basis weight of 30 GSM or less.

18. (canceled)

19. (canceled)

20. (canceled)

21. The nanofiber nonwoven product of claim 17, wherein the nonwoven product has a basis weight of from 4-10 GSM.

22. (canceled)

23. The nanofiber nonwoven product of claim 1 incorporated into filter media.

24. The nanofiber nonwoven product of any of claim 1 incorporated into a breathable fabric.

25. The nanofiber nonwoven product of claim 1 incorporated into apparel.

26. The nanofiber woven product of claim 1 incorporated into footwear.

27. (canceled)

28. (canceled)

29. A method of making a nanofiber nonwoven product comprising:
(a) providing a spinnable polyamide polymer composition comprising a solution of a polyamide in a suitable solvent, wherein the polyamide has a Relative Viscosity of from 30-300;
(b) solution-spinning the polyamide polymer composition into a plurality of nanofibers having an average fiber diameter of less than 1 micron (1000 nanometer); and
(c) forming the nanofibers into said nonwoven product which thereby has an average nanofiber diameter of less than 1000 nanometers, and,
(d) has a basis weight greater than 1 gm/m².

30. The method of making a nanofiber nonwoven product according to claim 29, wherein solution-spinning the polyamide is selected from (i) centrifugal spinning using a rotating spinneret or (ii) 2-phase propellant-gas spinning including extruding the polyamide polymer composition in liquid form with pressurized gas through a fiber-forming channel.

31. The method of making a nanofiber nonwoven product according to claims 29, wherein the solvent comprises a solvent selected from formic acid, sulfuric acid, trifluoroacetic acid, hexafluoroisopropanol (HFIP) and phenols including m-cresol .

32. The method of making a nanofiber nonwoven product according to 31, wherein the solvent comprises formic acid.

33. (canceled)

34. (canceled)

35. (canceled)

36. (canceled)

37. The method of making a nanofiber nonwoven product according to claim 29, wherein said polyamide composition comprises Nylon 6,6.

38. (canceled)

39. (canceled)

40. (canceled)

41. (canceled)

42. (canceled)

43.The method of making a nanofiber nonwoven product according to claim 29, wherein the polyamide has a Relative Viscosity of from 40-52.5.

44. The method of making a nanofiber nonwoven according to claim 29, wherein the nanofibers have a diameter of from 100-500 nanometers.

45. (canceled)

46. (canceled)

47. The method of making a nanofiber nonwoven product according to claim 29, wherein the nonwoven product has a basis weight of 30 GSM or less.

48. (canceled)

49. (canceled)

50. (canceled)

51. (canceled)
